(19) United States
(12) Patent Application Publication
(10) Pub. No.: US 2010/0218256 A1
(43) Pub. Date: Aug. 26, 2010

(54) SYSTEM AND METHOD OF INTEGRATING AND MANAGING INFORMATION SYSTEM ASSESSMENTS

(75) Inventors: Felix A. Thomas, Vienna, VA (US); Sadiyq Karim, Sterling, VA (US)

Correspondence Address: DUANE MORRIS LLP - DC, 505 9th Street, Suite 1000, WASHINGTON, DC, 20004-2166, US

(73) Assignee: Network Security Systems plus, Inc., Falls Church, VA (US)

(21) Appl. No.: 12/393,723

(22) Filed: Feb. 26, 2009

(51) Int. Cl. G06F 21/00

(52) U.S. Cl. 726/25

(57) ABSTRACT

A system and method for performing information system assessments, collecting the results, providing an analysis and evaluation of the results to provide a comprehensive and integrated assessment of the information system.

The present application is directed to a system and method of integrating and managing information system assessments.

Technological advances of the last decade have increased the interconnectivity of computer systems/networks, thereby fueling the growth of threats from hackers and criminals. As technology evolves, changes are required in the way information systems are protected. Industry standards are steadily emerging from the public and private sectors to provide guidelines for securing information systems including HIPAA, Sarbanes-Oxley, FISMA, DITSCAP, DIACAP and NIACAP.

As a result of the emerging industry standards, organizations must assure that adequate security is provided for any sensitive or private information collected, processed, transmitted, stored or disseminated. The overarching objective of information security is to protect systems and networks against attacks, breaches and down-time to ensure information availability, confidentiality and integrity. The potential costs and negative impacts of not being prepared and forearmed are far too great for any organization.

It is common for companies to employ individual software applications to verify compliance with the myriad of information security regulations promulgated recently including, Sarbanes-Oxley Act of 2002, Health Insurance Portability and Accountability Act (“HIPAA”), Federal Information Security Management Act of 2002, Family Educational Rights and Privacy Act (“FERPA”), Gramm-Leach-Bliley Act, Information Assurance Technical Framework (IATF), Dept. of Defense 8500 Policy Series and related documents, DISA Security Technical Implementation Guides (STIGs), and the National Security Agency (NSA)

However prior art vulnerability testing and management has been through a hodge-podge of individualized applications that provide results for individual tests but do not provide consolidated results or qualitative analysis of the consolidated results. As a result, it is common to have individual vulnerability assessments that produce overlapping results. Ultimately this may lead to duplicate results. Duplicate results can have a severe impact on vulnerability assessment and mitigation. Because most of the prior art analysis was done by hand after the individual assessments were completed, duplicates can greatly increase the amount of data to be analyzed. In addition, resources may be dedicated to mitigating a vulnerability that may have already been mitigated. Such inefficient use of resources greatly reduces the effectiveness of prior art vulnerability assessments.

Another shortcoming of the prior art assessments is the generation of false positives. A false positive causes resources to be expended needlessly and can severely hamper vulnerability mitigation efforts.

The present application is directed to performing thorough vulnerability assessments across a broad range of applications and providing consolidated vulnerability reporting and assessment and obviates many of the deficiencies of the prior art discussed above. The present disclosure includes a results processing engine which collects and analyzes the results from the standard vulnerability assessment tools, and compares the results with a predetermined criteria to provide additional analysis that was not previously provided in the prior art. This additional analysis allows the mapping of results to high level information assurance on control sets, the identification of the duplicate results, and the identification of false positives. The present disclosures allows for the categorization of each vulnerability that can assist in identifying unique relationships between vulnerability assessments that is helpful to identify root causes that was not possible with prior art systems.

### BRIEF DESCRIPTION OF THE DRAWINGS

FIG. 1 is a simplified flow diagram of one embodiment of the present invention.

FIG. 2 is a simplified pictorial representation of a display for a user interface illustrating the results from one embodiment of the present disclosure.

FIG. 3 is a simplified pictorial representation of a display for a user interface illustrating the results from one embodiment of the present disclosure.

FIG. 4 is a simplified pictorial representation of a display for a user interface illustrating the results from one embodiment of the present disclosure.

FIG. 5 is a simplified pictorial representation of a display for a user interface illustrating the results from one embodiment of the present disclosure.

FIG. 6 is a simplified pictorial representation of a display for a user interface for use with the document management module of the present disclosure.

### DETAILED DESCRIPTION

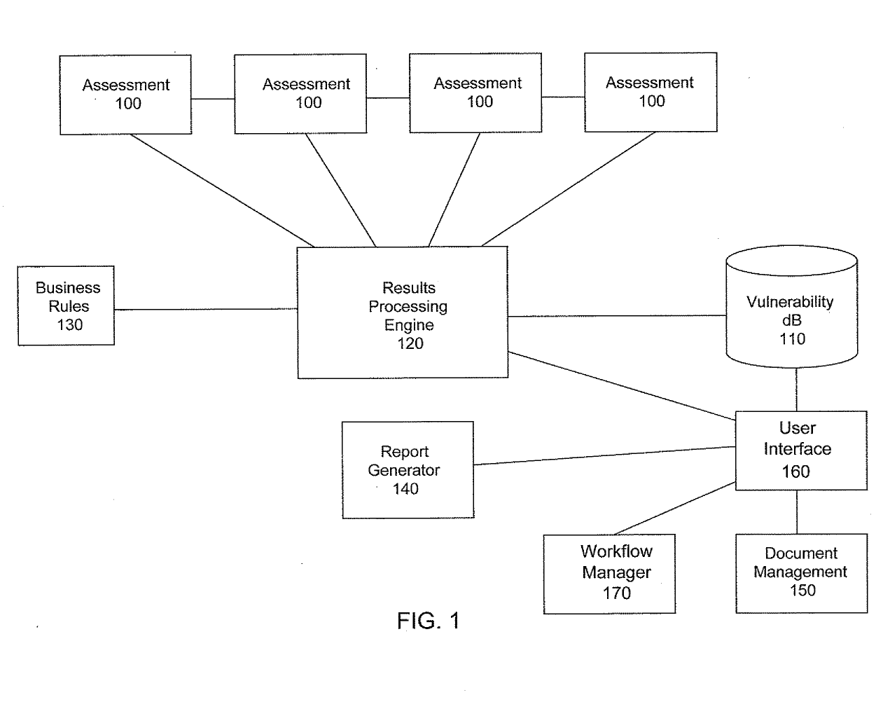

FIG. 1 illustrates the processes involved in one embodiment of the present disclosure. Assessment scans are performed on an information system 100. The assessments scans can include eEye Digital Retina Network Vulnerability Scanner; Application Security APPDetective Database Scanner, DISA Production Gold Disk, DISA Checklists, DISA Database UNIX and Web System Readiness Reviews (SRRs), HP/SpiDynamics Web Inspect, and other similar vulnerability assessment applications.

The results of the assessments are uploaded to a results processing engine 120. The results processing engine 120 analyzes the assessment results to identify trends. The results processing engine has access to a vulnerability database, and access to business rules to identify unique relationships between the assessment results. By having access to multiple vulnerability assessments, the results processing engine may be able to evaluate unique relationships across assessments to identify vulnerabilities that were not previously detectable using prior art assessments.

In one embodiment, a vulnerability database 110 contains historical vulnerability information such as past vulnerability assessment results, identification of previous vulnerabilities, rankings of the vulnerabilities, and the vulnerability results specific to a network, workstation or server. For example, the historical database 110 may identify for each vulnerability, whether the vulnerability had occurred in the past, the number of occurrences, the type of occurrences and the categories of the previous occurrences.

In another embodiment, the results processing engine 120 can apply business rules 130. Information assurance (IA) is an important pro-active component of an organization's security posture. IA involves the process of certifying and accrediting information systems according to documented security guidelines. By making use of information assurance methodologies, organizations can ensure that the implementation of their security policy meets the policy's stated objectives in addition to the guidelines of certifying authorities. For example, the Department of Defense (“DoD”) may identify 120 high level information assurance controls that need to be assessed to ensure compliance with DOD requirements. The results processing engine can map the results of the vulnerability assessments that it analyzes to the identified information assurance controls.

An important feature of the results processing engine 120 is the ability to correlate the results of many different vulnerability assessments in order to identify a root cause of a vulnerability. In one embodiment, for each vulnerability, the results processing engine identifies a type of vulnerability, the risk rating of the vulnerability and the classification of the vulnerability in order to identify a root cause.

The type of vulnerability identifies where the vulnerability exists. For example, in one embodiment the types of vulnerabilities can be server, workstation, network, device, mainframe, database, web application and the like.

A risk rating is normally provided by the vulnerability assessment tool and is normally portrayed as a high, medium or low risk. The results processing engine 120 has the ability to analyze the provided risk results and modify the results as a function of user defined business rules. For example, in one embodiment, a user may wish to reclassify any risk relating to password protection as high. If a vulnerability assessment identifies a vulnerability associated with a password and provides a risk rating of medium, the results processing engine 120 will reclassify the risk rating as high.

A risking rating can be determined based on the probability of occurrence of an identified vulnerability. For example, database 110 can store the historical results of past vulnerability assessments including vulnerability occurrences. The risk rating can be determined based on an analysis of the stored historical data and determining the most likely vulnerability to occur. The risk rating also may be based on identity of the specific type of soft or hardware, the type of vulnerability, the type of industry that the software is utilized in and is fully customizable and changeable. For instance if a known denial of service threat has been released to attack systems in the financial industry, the present disclosure allows the ability to select a higher risk rating for denial of service vulnerabilities, and a higher risk for systems accessed by the financial industry. The risk rating may also be selected as a function of a host internet protocol (IP) address.

The classification of the vulnerability can also be user defined. In one embodiment, the classification can be identified as an authentication vulnerability, an encryption vulnerability or a denial of service vulnerability.

The results processing engine 120 analyzes the type risk rating and category of the vulnerability to determine the root cause. Once the root cause is determined, the result processing engine can identify a mitigation for the vulnerability. The ability to identify the root cause is an important feature. For example, as a result of running plural assessments tools, it may be determined that a work station vulnerability, a server vulnerability and a network vulnerability all exist. In the prior art, each one of the vulnerabilities would be addressed independently, and a mitigation plan would be implemented. In the present application, the results processing engine can identify a root cause or causes of the vulnerability and use the root cause to identify correlations between the vulnerabilities. If the network vulnerability is correlated to the workstation vulnerability and the server vulnerability, then it may only be necessary to address the work station and the server vulnerability, which will mitigate the network vulnerability without requiring further mitigation. Thus by identifying the root cause, the results processing engine can identify correlation between vulnerabilities and simplify the mitigation process. For example, in one embodiment, the vulnerability assessment tools may identify an internal vulnerability and also that the firewall is free from any vulnerabilities. In the prior art, the internal vulnerability may be given a high risk rating and thus require resources to mitigate the internal vulnerability. However, in this embodiment, the results processing engine 120 may reduce the risk rating of the internal vulnerability because of the presence of a strong firewall thereby avoiding dedicating resources to mitigate the identified internal vulnerability. Thus, the results processing engine 120 can correlate the vulnerability results and increase or decrease vulnerability risks associated with one of the identified results as a function of the correlation between the identified vulnerabilities.

In one aspect, the results processing engine reviews the assessment results for quality assurance. In one embodiment, the results processing engine can identify false positives. For example, a vulnerability assessment tool may check the registry of a computing system to identify a predefined sequence of upper case letters. If the upper case letters are not located, a vulnerability may be identified by the assessment tool. The results processing engine may verify that the predefined sequence of letters is present in the registry, but the letters are lower case and not upper case. Thus, the identified vulnerability is a false positive. Another example of results processing engine to locate a false positive resides in the correlation engine. An assessment tool may analyze a systems anti-virus vulnerability. As part of the assessment, the tool may inquire as to

(1) whether anti-virus applications are installed in the system;

(2) is the latest version of the anti-virus application installed?

(3) is the latest scan available?

In prior art tools, if no anti-virus applications are installed, the response to the three questions will result in a vulnerability being identified for each question. The results processing engine may analyze the results, and through its correlation engine recognize that a negative response to the first question necessarily means that the second and third question will also be answered in the negative. However, the results processing engine will recognize the root cause as being the absence of anti-virus software, and disregard the false positives generated by the other responses. The results processing engine 120 may also access the database 110 to identify previous false positives generated during prior scans of the same computing system. An analysis of previous false positives may help identify false positives currently being generated. If no prior scans for the system are available, the results processing engine 120 can access the database 110 for assessments from other computing systems that may likewise assist in the identification of false positives.

The rules processing engine 120 takes testing results from DoD and industry standard vulnerability assessment tools and processes the data into a common database format while mapping individual vulnerabilities to Information Assurance Controls (IAC). This process saves validators the level of effort associated with manually correlating output data from different vulnerability assessment tools. The rules processing engine 120 is based on a modular architecture and has a schema that can support virtually any vulnerability assessment tool with or without structured output and generates management and trend analysis reports. For example the rules processing engine 120 can supports the following vulnerability assessment tools:

eEye Digital Retina Network Vulnerability Scanner

Application Security AppDetective Database Scanner

DISA PGD (version 2)

DISA Checklists

DISA Database, Unix and Web SRRs

HP/SpiDynamics WebInspect

However, the rules processing engine 120 is not limited to the use of the above tools, but instead employs a flexible architecture that is able to support additional tools based on user demand.

System users upload their validation results through a system interface and correlate them with a certification and accreditation package. The rules processing engine 120 then extracts the vulnerability information and test cases that were successfully passed and performs the IAC mapping. The rules processing engine 120 also automatically identifies and tags duplicate findings across vulnerability assessment tools. The results processing engine 120 is able to quickly identify duplicate results by comparing the results from the different assessment tools. The duplicates can be flagged or removed and thus eliminated from further analysis or corrective action. This is a common occurrence between PGD and Retina, for instance. In addition to extracting passed and failed test cases automatically, the rules processing engine 120 also extracts test case results when available from vulnerability assessment tools. This data represents the response received from a host when the vulnerability assessment tool performed a test case. For example, PGD performs a check for Dormant Accounts. The test case results for the Dormant Account check include the actual dormant accounts that were identified by the system. This information is vital to system owners responsible for remediating identified system weaknesses. By empowering system agents and validators with consolidated normalized test results in an automated manner, personnel can focus their efforts on the risk analysis and remediation tasks required and less time is spent conducting data processing tasks. Information System Security Engineers can now conduct their validation testing and generate a comprehensive validation report 140 and draft DIACAP Scorecard and POA&M in the same day. System agents can now quickly ascertain system weaknesses that require remediation. This process brings a new level of efficiency to the part of the C&A process that is most susceptible to delay in the overall schedule. A system vulnerability module lists identified weaknesses in a grid format and allows agents and validators to identify false positives, weaknesses that have been fixed, and weaknesses requiring defense in depth (DiD) mitigation in a simple format.

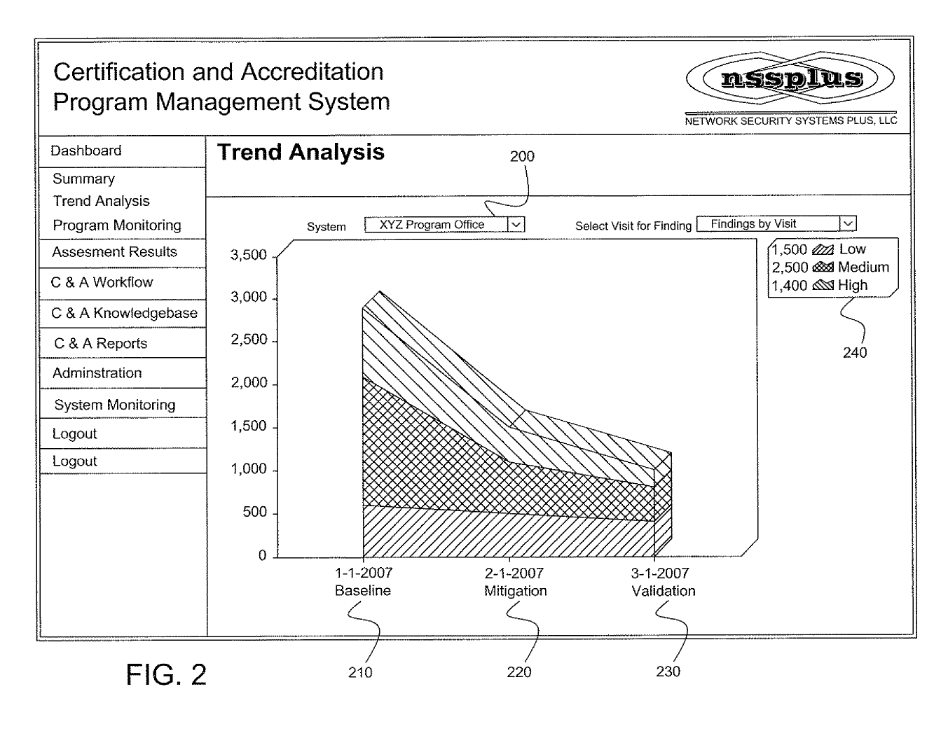

The results processing engine 120 can be used to identify that the mitigation implemented in response to known vulnerabilities is effective. FIG. 2 illustrates one embodiment of a user interface 160 displaying an analysis from the results processing engine 120. The results processing engine 120 analyzes vulnerability assessments to identify trends. The results processing engine 120 has access to a vulnerability database, and access to business rules to identify unique relationships between the assessment results. For a given entity 200, the results processing engine 120 can assess the vulnerability tools over time to allow trend analysis. For example, the rules processing engine 120 can be used at the start of a certification and accreditation process to establish a baseline 210. Once mitigation efforts have been identified and implemented, the rules processing engine 120 can be used to check the effectiveness of the mitigation efforts 220. The rules processing engine can be further run at validation to ensure compliance with required specifications 230. The results may be present with an identification of the level of the vulnerability low/medium/high 240 to allow a qualitative evaluation of the trend analysis.

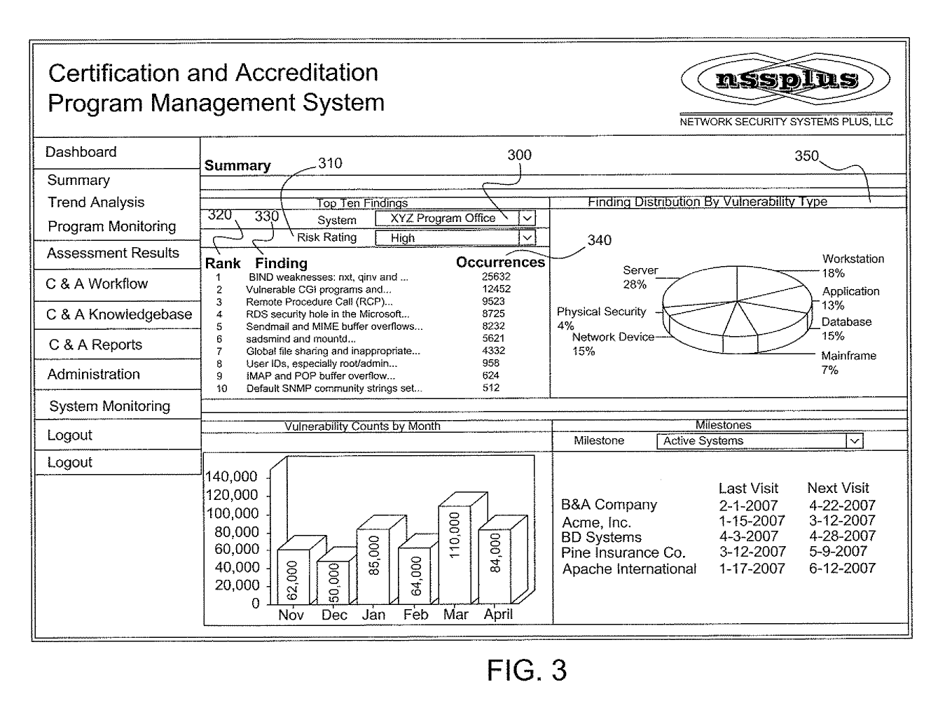

FIG. 3 illustrates one embodiment of a user interface display of the risk rating analysis of the results processing engine 120. For a given entity 300, the rules processing engine 120 can rank the risk rating 310 of the consolidated results of vulnerability assessments 100. The risk rating 310 can include the rank 320, the identification of the vulnerability 330 and the number of occurrences 340. The risk rating ranking can take into account the number of occurrences, the severity of the vulnerability, the identification of the vulnerability, the type of vulnerability, the trend of a vulnerability, and other customized metrics for identifying a risk for a specific customer.

The rules processing engine can also identify a vulnerability on the basis of the type of vulnerability 350 which provides a useful tool for identifying a system that is most susceptible to a vulnerability. The type of vulnerability can be classified as a function of the type of entity affected and can include server, physical security, network device, workstation, applications, database and mainframe.

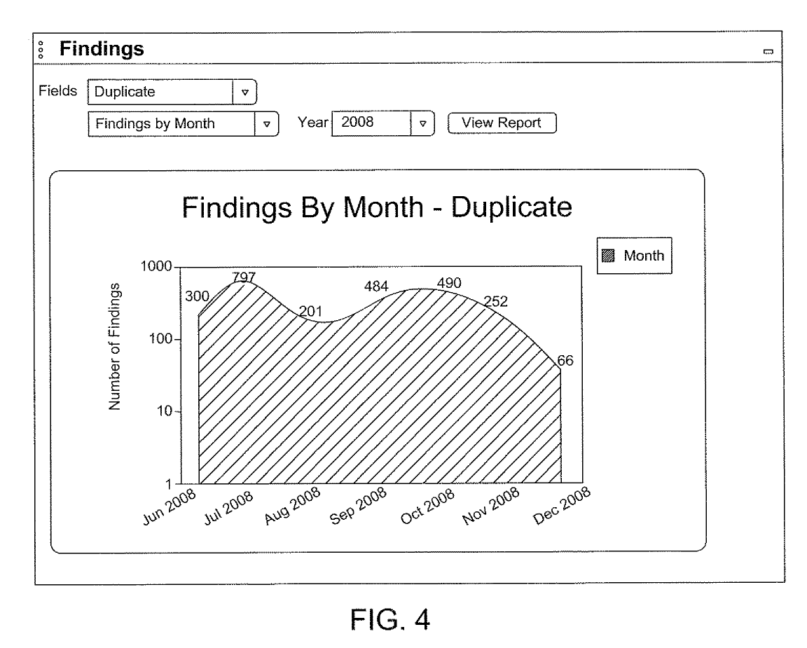

The user interface 160 provides the ability to customize the results of the certification and accreditation process and allows the drill down of the results. The analysis and evaluation of the rules processing engine 120 can be accessed from the vulnerability database 110 and trend analysis can be performed across many different clients to help fine tune the analysis. For example, FIG. 4 illustrates one embodiment of a user interface display of a trend analysis for duplicate vulnerability findings. The number of duplicate findings by month can be correlated with different techniques that may have been implemented in an effort to reduce duplicates. The trend analysis improves the ability to evaluate the effectiveness of duplication elimination techniques.

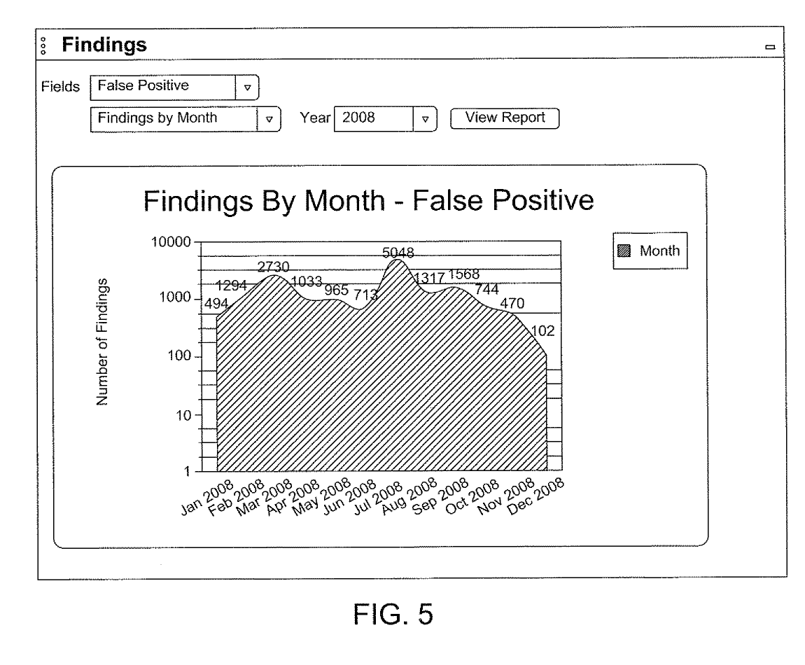

FIG. 5 illustrates one embodiment of a user interface display of a trend analysis for false positives. The display of the results of the rules processing engine 120 can be customized. For example, the false positives can be displayed over all clients by month as shown in FIG. 5, or can be displayed by vulnerability over time, or by vulnerability over client type, or vulnerability type over time, etc. Once the results processing engine has been run and the results stored in the database 110, the results and analysis can be manipulated by the user interface 160 to evaluate relationships and correlations that were not practically available in the prior art systems.

The results processing engine 120 can provide the results to a report generator 140. Reports may then be generated from the analysis performed by the results processing engine. These consolidated reports may identify system vulnerabilities and identify remediation and corrective actions. The document management module 150 integrates with the vulnerability database 110 to identify the certification and accreditation efforts and their associated documents. Through this integration, the present application is able to enumerate not only the vulnerabilities identified during a security assessment but also the associated documentation requirements. The document management module 150 allows users though interface 160 to import, export, and query documents based on document type or content. Users can also checkout and checkin documents. The document management interface provides a unique approach to displaying documents by grouping documents by document type and providing a group header for each document type. The document management module 150 uses a unique database driven design that allows administrator to establish logical storage containers based on the certification and accreditation system and site definitions in the vulnerability database 110. This simplifies the process of establish repositories to store certification and accreditation documentation. The document management module 150 also utilizes a unique concept of search folders that allow an administrator to define document types that will be queried when a user clicks on a certain icon in the user interface 160. The search folders are used to align with the DoD Information Assurance Certification and Accreditation Process (DIACAP) certification and accreditation package requirements and the NIST 800-53 certification and accreditation package requirements.

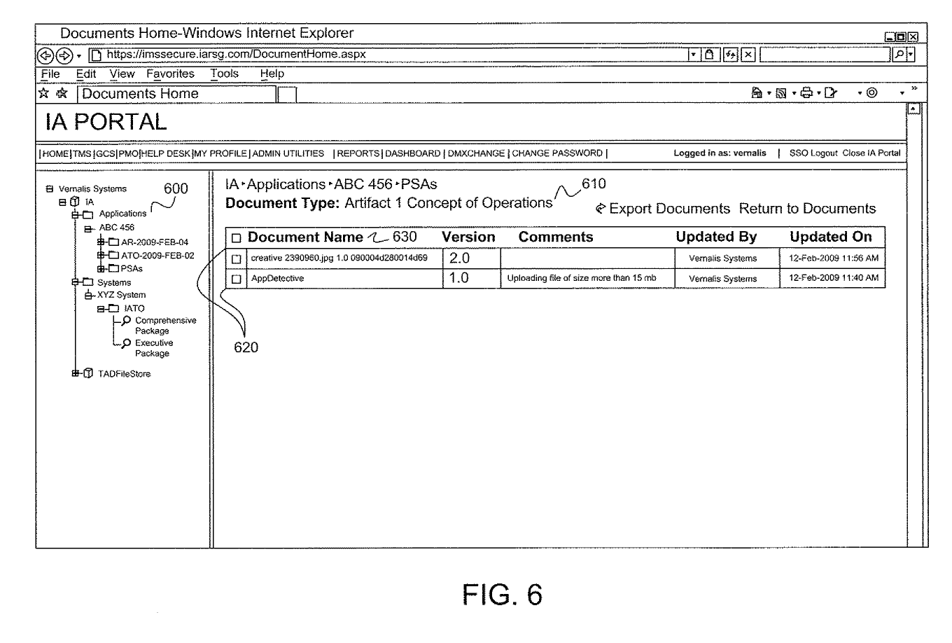

FIG. 6 illustrates a screen shot of user interface 160 for use with document management module 150. Documents associated with a specific information assessment application 600 can be selected for display. The documents can be displayed by document type 610. Each document 620 can be displayed by document name 630 and allows the user to display, import, export, and query the documents.

The purpose built workflow module 170 allows users to define workflow processes for the end to end certification and accreditation lifecycle from the initial documentation requirements through security testing, processing security testing results, through the final documentation package requirements. Prior art systems lacked the ability to integrate the end to end workflow of the certification and accreditation process to include the vulnerability scanning and workflow functions provided by the results processing engine 120 along with documentation workflow components for a true unified solution.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal that is generated to encode information for transmission to suitable receiver apparatus for execution by a computer. The computer readable medium can be a machine-readable storage device, a machine-readable storage substrate, a memory device, a composition of matter affecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although a few embodiments have been described in detail above, other modifications are possible. Other embodiments may be within the scope of the following claims.

It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

What is claimed:

1. A method of determining a vulnerability of an information system, comprising the steps of:
(a) utilizing a first computer application to perform a first vulnerability assessment;
(b) utilizing a second computer application to perform a second vulnerability assessment;
(c) analyzing the stored results using a results processing engine; and
(d) identifying a vulnerability as a function of the analyzed results.

2. The method of claim 1 further comprising the steps of:
(e) determining the probability of occurrence of an identified vulnerability; and
(f) ranking the identified vulnerabilities as a function of probability of occurrence.

3. The method of claim 2 wherein the step of determining the probability of occurrence including accessing an historical database.

4. The method of claim 2 further comprising the step of generating a report listing the identified vulnerabilities.

5. The method of claim 1 wherein the first computer application includes at least one of eEye Digital Retina Network Vulnerability Scanner; Application Security APPDetective Database Scanner, DISA Production Gold Disk, DISA Checklists, DISA Database UNIX and Web System Readiness Reviews (SRRs), HP/SpiDynamics Web Inspect.

6. The method of claim 1 wherein the step of analyzing includes applying business rules.

7. The method of claim 1 wherein the step of analyzing includes accessing a database of historical assessments.

8. The method of claim 1 including storing the results of the first and second vulnerability assessments

9. The method of claim 1 wherein the identification of the system vulnerability includes an identification of the affected component and the type of vulnerability.

10. The method claim 1 wherein the step of determining the probability of occurrence is based on historical analysis.

11. The method of claim 1, further comprising the steps of results;
(e) classifying the identified vulnerability;
(f) determining a root cause of the vulnerability as a function of the classification.

12. The method of claim 11 wherein the step of classifying includes classifying the vulnerability as at least one of an authentication vulnerability, an encryption vulnerability and a denial of service vulnerability.

13. The method of claim 12 further comprising the step of risk rating a vulnerability based on the accessed historical database.

14. The method of claim 13 where the risk rating is based on whether an identified vulnerability previously occurred.

15. The method of claim 13 where the risk rating is based on a host IP address.
